(19) United States
(12) Patent Application Publication
(10) Pub. No.: US 2018/0354574 A1
(43) Pub. Date: Dec. 13, 2018

(54) HOLDER FOR A TWO-WHEELER LOCK

(71) Applicant: ABUS August Bremicker Söhne KG, Wetter-Volmarstein (DE)

(72) Inventor: Thomas Müller, Bischoffen (DE)

(21) Appl. No.: 16/001,756

(22) Filed: Jun. 6, 2018

(30) Foreign Application Priority Data
Jun. 9, 2017 (DE) 102017112766.6

(51) Int. Cl. B62J 11/00; E05B 71/00; B62H 5/00

(52) U.S. Cl. CPC B62J 11/00; B62H 5/00; E05B 71/00

(57) ABSTRACT

A holder, for a two-wheeler lock of a folding lock type, includes a carrier that extends along a longitudinal axis and that has a fastening device for fastening the carrier to a tube section of a two-wheeler, wherein the carrier bounds a reception region for receiving the two-wheeler lock, and further comprises a fixing hoop that is supported at the carrier pivotable between an open position and a closed position, wherein the fixing hoop is configured to fix the two-wheeler lock in the reception region in the closed position. The fixing hoop has at least one spring section that is configured to exert a pressing force on the lock in the closed position of the fixing hoop.

### CROSS-REFERENCE TO RELATED APPLICATIONS

This application claims priority to German Patent Application No. DE 102017112766.6 filed on Jun. 9, 2017, the entire contents of which are incorporated herein by reference.

### TECHNICAL FIELD

The present disclosure relates to a holder for a two-wheeler lock of the type of a folding lock comprising a carrier that extends along a longitudinal axis and that has a fastener that fastens the carrier to a tube section of a two-wheeler, wherein the carrier bounds a reception region for receiving the two-wheeler lock, and further comprising a fixing hoop that is supported at the carrier pivotable between an open position and a closed position, wherein the fixing hoop is configured to fix the two-wheeler lock in the reception region in the closed position.

### BACKGROUND

Folding locks serve, for example, for the securing of a two-wheeler to a bicycle stand, to a lamppost or the like. For this purpose, the folding lock comprises a lock body and a jointed bar hoop which is fastened thereto and which has a plurality of jointed bars which are pivotably connected to one another and which may be folded together to form an axial parallel arrangement. The jointed bars are folded apart for the use of the folding lock to form an open loop that may, for example, engage around a frame section of the two-wheeler and the bicycle stand, lamppost or the like. To secure the two-wheeler against unauthorized use, the loop is then closed and a free end of the loop or of the jointed bar hoop is latched to the lock body.

The jointed bars may be folded together after an unlatching of the folding lock to form a compact arrangement (a so-called yardstick configuration) for the transport of the folding lock by the authorized user during a trip. The folding lock may be received in the holder in this configuration. Such holders are typically secured to a tube section of the frame, of the bicycle luggage carrier or of the seat tube of the two-wheeler.

An exemplary folding lock is known from DE 10 2005 040 066 B4. DE 20 2005 013 390 U1 describes a bag for a folding lock.

When the holder is equipped with a pivotable fixing hoop, a simple operation and an intuitively initial handling of the holder results for the user since the fixing hoop only has to be pivoted into the closed position to fix the two-wheeler lock in the reception region of the holder. A particularly simple handling results in this respect when a free end of the fixing hoop is blockable, i.e. locationally fixable, at the carrier by a latch device that maintains the closed position of the fixing hoop. It should, however, be ensured in this respect that the latch connection is reliably maintained, in particular also on vibrations during the trip with the two-wheeler.

It is disadvantageous when the two-wheeler lock received in the holder swings to and fro within the holder, for instance due to a lateral clearance due to production tolerances, during the trip with the two-wheeler due to the vibrations that occur here. This may result in unwanted noise or wear of the two-wheeler lock.

### SUMMARY

It is an object of the present disclosure to provide a holder for a two-wheeler lock of the type of a folding lock that eliminates the aforesaid disadvantages and is in particular simple to handle.

This object is satisfied by a holder having the features disclosed in the following description and the Figures.

In some embodiments, the holder includes a carrier and a fixing hoop. The carrier extends along a longitudinal axis and has a fastener that fastens the carrier to a tube section of a two-wheeler. The carrier bounds a reception region that receives the two-wheeler lock. The fixing hoop is supported at the carrier pivotable between an open position and a closed position, with the fixing hoop being configured to fix the two-wheeler lock in the reception region in the closed position. The fixing hoop has at least one spring section that is configured to exert a pressing force on the two-wheeler lock in the closed position of the fixing hoop.

With this holder for a two-wheeler lock, a pivotable fixing hoop is accordingly formed with at least one spring section. A closed position of the fixing hoop is made possible by the spring section using a pressing force that is effective between the fixing hoop and the two-wheeler lock located in the reception region of the holder. This pressing force and in particular also the counter-force (reaction force) generated between the two-wheeler lock and the carrier as well as the friction forces effective in the lateral direction improve the fixing of the two-wheeler lock in the reception region. Any possible clearance with locks not exactly fitting in the reception region of the holder may also be eliminated by formation of a spring section. Both the two-wheeler rider and the two-wheeler lock are protected by an improved fixing of the two-wheeler lock.

On the one hand, a possible falling out of the two-wheeler lock on possibly occurring vibrations during the trip are counter-acted. On the other hand, the two-wheeler lock itself is protected from wear, in particular due to a to-and-fro movement within the reception region due to a possible clearance. An unwanted noise formation due to “clattering” of the two-wheeler lock or of its components is effectively suppressed.

The provision of such a spring section is particularly useful when the fixing hoop is supported at the carrier freely pivotable between the open position and the closed position, for example by a hinge as explained in the following. A tensioning of the spring section to generate the explained pressing force for fixing the two-wheeler lock hereby only takes place on the final closing of the fixing hoop, i.e. on the final reaching of the closed position. The fixing hoop may thus be moved substantially force-free, and in particular with only one hand, in the direction of the closed position, with the user only generating the explained pressing force on the final closing of the fixing hoop and hereby also receiving haptic feedback on the reaching of the closed position.

The provision of a spring section at the fixing hoop is furthermore useful when the fixing hoop is secured to the carrier at its free end by a latch device in its closed position, as will be explained in the following. The pressing force generated by the spring section between the fixing hoop and the two-wheeler lock may here be effective as a counter-force at the latch device to there effect a particularly reliable latch connection (between the latch element and the counter-element).

In accordance with some embodiments, the fixing hoop is aligned transversely to the longitudinal axis of the carrier. The two-wheeler lock is held in the reception region in the closed position of the fixing hoop by the fixing hoop in the transverse direction and is in particular secured in the lateral direction against a leaving of the reception region (e.g. by tilting out). The freedom of movement perpendicular to the longitudinal axis of the carrier is limited by the direction of extension of the fixing hoop perpendicular to the direction of extension of the carrier.

In accordance with some embodiments, the spring section is resilient. On an elastic deformation of the spring section, a return force may thus be produced to generate the explained pressing force on the two-wheeler lock. Due to the resilient property of the spring section, the pressing force may therefore be exerted on the two-wheeler lock located in the reception region. A stable and secure fixing of the lock is thus possible by the resilient spring section.

The spring section may in particular be resilient in a direction that extends transversely (and in some embodiments perpendicular) to the direction of extension of the spring section.

The fixing hoop itself, or a part of the fixing hoop (and in some embodiments a base section) may in particular form the spring section, with the fixing hoop or the part of the fixing hoop forming the spring section being resilient.

In accordance with some embodiments, the spring section may be obliquely aligned with respect to the direction of extension of the fixing hoop. The spring section may hereby project over the plane of extension of the fixing hoop in the environment of the spring section, in particular in the direction of the reception region for the two-wheeler lock (with respect to the closed position of the fixing hoop). The orientation of the spring section may be defined with respect to the direction of extension of the fixing hoop by an acute angle in some embodiments. The fixing of a two-wheeler lock in the reception region is improved by an oblique alignment of the spring section relative to the fixing hoop (at least in the environment of the spring section) due to the pressing force thereby increased.

The spring section may in particular be inclined in the direction of the reception region for the two-wheeler lock with respect to the direction of extension of the fixing hoop.

The creation of the pressing force by increased pressure on the two-wheeler lock by the inclination of the spring section in the direction of the reception region.

In accordance with some other embodiments, the spring section is formed integrally, i.e. with material continuity in one part, at the fixing hoop. The spring section may hereby be manufactured in a particularly simple manner since no separate production or fastening of the spring section is necessary. Furthermore a possible wear by friction of individual components in the spring section is hereby counteracted. In addition, a constant, resilient effect of the spring section is made possible since no fasteners (for example screws, spring elements) may loosen or release.

In accordance with some embodiments, the spring section is formed by a multi-side opening at the fixing hoop. As such, the spring section is deformable to adapt to the geometry of a two-wheeler lock by a partial peripheral opening of the spring section without impairing the fixing function of the fixing hoop.

The spring section may in particular be formed in tongue shape. A reliable fixing of the received two-wheeler lock with simultaneously small deformation and small wear is achieved by such a shape of the spring section. In addition, the shape, which is simple in comparison with a complex shape, facilitates the manufacture of the spring section and thus of the total fixing hoop.

In accordance with some other embodiments, the fixing hoop has a web section, wherein the spring section projects from the web section in the direction of the reception region for the two-wheeler lock. The web section may thus connect the free-standing spring section to the fixing hoop and may hereby enable an alignment of the spring section in the direction of the reception region for the two-wheeler lock. The plane of extension of the web section may here in particular extend (with respect to the closed position of the fixing hoop) in parallel with the plane of extension of the carrier. Since the spring section projects toward the reception region, an increased pressing force is made possible on the two-wheeler lock located in the reception region. The opening of the spring section may moreover be realized by the web section.

In accordance with some embodiments, the fixing hoop has two spring sections. The two spring sections may here in particular be connected to one another in a central region of the fixing hoop. The two spring sections and their openings may in particular be realized with the aid of the above-named web section. In some embodiments, the web section is centrally positioned, with respect to the length of extension of the fixing hoop, and thus separates the two spring sections from one another. An even more reliable fixing of the two-wheeler lock located in the reception region may be achieved by the use of two spring sections.

In accordance with some embodiments, the two spring sections face in mutually at least substantially opposite directions, apart from a slanted position in the direction of the receiving region for the two-wheeler lock. Due to the different directions of the spring sections, a mutual impairment of the pressing forces by the spring sections is suppressed and the spring sections may engage at different points of the two-wheeler lock.

In accordance with some embodiments, the fixing hoop is elastic perpendicular to its direction of extension, but not along its respective direction of extension. As such, a respective section of the fixing hoop may be bent in a resilient manner, but cannot be pulled apart elastically along its longitudinal extension. This in particular also applies to a plurality of sections of the fixing hoop facing in different directions, for example when the fixing hoop is substantially of U shape, with in this case the U shape overall being able to have a certain elasticity (by bending the individual sections relative to one another). Such a restricted elasticity of the fixing hoop may simplify the handling of the fixing hoop. Provision may in particular be made that the fixing hoop does not have to be longitudinally stretched by an undesirably high force effort for the bringing into the closed position. An elasticity of the fixing hoop in the lateral direction may, however, enable or assist a force-fitting fixing of the two-wheeler lock in the reception region of the carrier by the spring section.

In accordance with some embodiments, the fixing hoop or a part of the fixing hoop (in some embodiments the base section) is convexly arched with respect to the reception region for the two-wheeler lock. The pressing force of the spring section on the two-wheeler lock located in the reception region may be generated by a convex arching (in particular when the spring section is formed by the fixing hoop itself or by a part hereof) or it may be assisted (in particular when the spring section is arranged at the convexly arched part of the fixing hoop). In some embodiments, the convexly arched fixing hoop or part of the fixing hoop is elastic in a direction perpendicular to its direction of extension.

In accordance with some embodiments, the fixing hoop surrounds the reception region for the two-wheeler lock in the closed position. The peripheral direction of the reception region in this connection in particular relates to the longitudinal axis of the carrier, i.e. the periphery extends at least substantially along an orthogonal plane with respect to the longitudinal axis of the carrier. A securing of the two-wheeler lock against a lateral falling out or tilting out is achieved by the reception region closed along the total periphery.

In accordance with some other embodiments, the fixing hoop is substantially of U shape, with the fixing hoop having a base section that is arranged between two limb sections. A surrounding of the typically parallelepiped-shaped reception region is possible through the U-shaped design of the fixing hoop. The two-wheeler lock may hereby be firmly fixed and secured against a lateral leaving of the reception region. In some embodiments, the spring section or the spring sections are provided at the base section.

In accordance with some embodiments, the fixing hoop is at least substantially of stable (or rigid) shape. A simplified handling is made possible by the shape stability of the fixing hoop in comparison with fixing hoops not of stable shape (for example a tab manufactured from an elastomer) since the user does not have to apply any additional force (and optionally counter-force for support) to adapt the shape of the fixing hoop to the outline of the two-wheeler lock on the closing of the fixing hoop.

In accordance with some embodiments, the fixing hoop is pivotably supported at the carrier by at least one hinge. A simple and in particular one-handed opening and closing of the fixing hoop is possible due to the pivotable support of the hinge. A free pivotability of the fixing hoop is in particular hereby possible, with the fixing hoop first being moved substantially free of force in the direction of the closed position and with the user only tensioning the spring section against the two-wheeler lock and in so doing generating the explained pressing force on the final closing of the fixing hoop.

In accordance with some embodiments, the hinge may comprise a cylindrical hinge pin of the carrier. The movement of the fixing hoop into the open or closed position is made possible by the cylindrical hinge pin. In contrast to, for example, a tab molded on with material continuity or to a ball joint, fewer degrees of freedom in the movement of the fixing hoop is achieved by the cylindrical hinge pin. Only a single pivot axis for the movement of the fixing hoop hereby results, from which a simple, intuitive and low-wear handling is made possible with few canting possibilities of the fixing hoop. The hinge may furthermore comprise a hinge bracket of the fixing hoop that is provided at an end of the fixing hoop (also called a hinge end in the following) and partially peripherally engages around the hinge pin of the carrier.

In accordance with some embodiments, the fixing hoop is pivotable about a pivot axis that extends in parallel with the longitudinal axis of the carrier.

In accordance with some other embodiments, the fixing hoop has a free end (also called the closure end in the following) which is latchable to the carrier by a latch device to block the fixing hoop at the carrier in its closed position. A simple and in particular one-handed opening and closing of the fixing hoop is possible by the provision of a latch device. The fixing hoop is firmly fixed and the two-wheeler lock is securely fixed in the reception region of the holder by the latch device. The fixing hoop remains closed on a trip on the two-wheeler due to the latch device. The pressing force, that is generated by the spring section of the fixing hoop between the fixing hoop and the two-wheeler lock located in the receiving region of the holder, may here be effective as a counter-force at the latch device in order there to effect a particularly reliable latch connection.

In accordance with some embodiments, the fixing hoop has at least one hinge end (that may in particular be associated with the hinge) and one closure end (that may in particular correspond to the free end of the fixing hoop). The carrier may in this respect have a first connection section and a second connection section of a similar nature to the first connection section, respectively, at two sides of the reception region for the two-wheeler lock. In some embodiments, the fixing hoop may be selectively fixed to the carrier in a first configuration or in a second configuration. In the first configuration, the hinge end of the fixing hoop is fastened to the first connection section of the carrier and the closure end of the fixing hoop is blockable at the second connection section of the carrier (for the closed position of the fixing hoop). In the second configuration, the hinge end of the fixing hoop is fastened to the second connection section of the carrier and the closure end is blockable at the first connection section (for the closed position of the fixing hoop). The connection sections of the carrier thus selectively act either as a hinge element or as a latch element. It is therefore selectively possible that the hinge end is fastened to the respective connection section of the carrier or that the closure end of the fixing hoop is blocked at the respective connection section of the carrier in the closed position of the fixing hoop, with the respective fastening or blocking (with a different force effort and/or in a different angle position of the fixing hoop) being releasable. The mechanism of the opening and closing may, for example, be adapted to left handed or right handed persons by the simple possibility of such a reconfiguring of the fixing hoop. The direction of opening and closing of the fixing hoop may furthermore also be adapted to different circumstances, for example to the parked position of the two-wheeler in a cellar compartment.

The present disclosure also relates, independently of the presence of the spring section, to a holder for a two-wheeler lock of the type of a folding lock having a carrier that extends along a longitudinal axis and to a fastern that fastens the carrier to a tube section of a two-wheeler, wherein the carrier bounds a reception region for receiving the two-wheeler lock, and having a fixing hoop that is supported at the carrier pivotable between an open position and a closed position, with the fixing hoop being configured to fix the two-wheeler lock in the reception region in the closed position, with the direction of opening and closing of the fixing hoop being reconfigurable in the above-explained manner (that is by provision of two similar connection sections of the carrier and a corresponding configuration of the fixing hoop).

In accordance with some embodiments, the carrier has a support element that is configured to support the two-wheeler lock received in the reception region against a movement along the longitudinal axis of the carrier. The support element may in this respect in particular downwardly bound the reception region in order, for instance to prevent a slipping of the two-wheeler lock through the reception region and/or may upwardly bound it to prevent a jumping out of the two-wheeler lock during the trip due to a vibration. Such a support element may also serve to provisionally position the two-wheeler lock inserted into the reception region of the holder in the closed position of the fixing hoop until the fixing hoop is closed.

In accordance with some embodiments, the support element projects laterally with respect to the longitudinal axis of the carrier to support the two-wheeler lock at a front side or to engage into a cut-out of the two-wheeler lock.

In accordance with some other embodiments, the support element is at least substantially rigidly connected to the carrier and is in particular formed integrally with the carrier.

The carrier of the holder may have a support shell in a lower region that has a bottom, a front wall and two side walls, with the two side walls extending further upwardly relative to the front wall to provide a high lateral stability of the held two-wheeler lock, and with the bottom of the support shell forming the support element.

In some embodiments, the holder may have a plate that extends along the longitudinal axis.

In accordance with some embodiments, the carrier has a contact plate at its rear side that consists of a softer material than the carrier. An improved contact of the carrier at the tube section of the two-wheeler may hereby be achieved, with the contact plate in particular being able to have a coefficient of friction increased (relative to the carrier) and/or being able to effect a damping. The contact plate may be releasably fastened to the carrier or may be formed integrally with the carrier (for example as a so-called 2K or two component injection molded part).

The carrier or the contact plate may have a concave cross-section at the rear side to achieve an improved shape matching with the tube section of the two-wheeler.

The carrier may, for example, have a plurality of fastening openings distributed along the longitudinal axis of the carrier for leading through fasteners, such as screws, and/or may have lateral slits for leading through a fastening band (e.g. using a hook and loop fastener element).

The holder may generally be produced from a wear-resistant polymer.

The present disclosure relates to a lock arrangement having a holder in accordance with one of the aforesaid embodiments and having a two-wheeler lock of the type of a folding lock, with the two-wheeler lock having a lock body and a jointed bar hoop which is fastened thereto and which has a plurality of jointed bars which are pivotably connected to one another and which may be folded together to form an axially parallel arrangement.

### BRIEF DESCRIPTION OF THE DRAWINGS

The present disclosure will be explained in the following only by way of example with reference to the drawings. Elements which are the same or of a similar kind are marked by the same reference numerals therein.

FIG. 1 shows a perspective view of a holder for a two-wheeler lock with a fixing hoop in the closed position obliquely from the front;

FIG. 2 show a front view of the holder with the fixing hoop in the closed position;

FIG. 3 shows a side view of the holder with the fixing hoop in the closed position;

FIG. 4 shows a perspective view of the holder with the fixing hoop in the open position obliquely from the front;

FIG. 5 shows a perspective view of the holder with a two-wheeler lock received therein obliquely from the front; and

FIG. 6 shows a perspective view of a further embodiment of a holder for a two-wheeler lock obliquely from the front.

### DETAILED DESCRIPTION

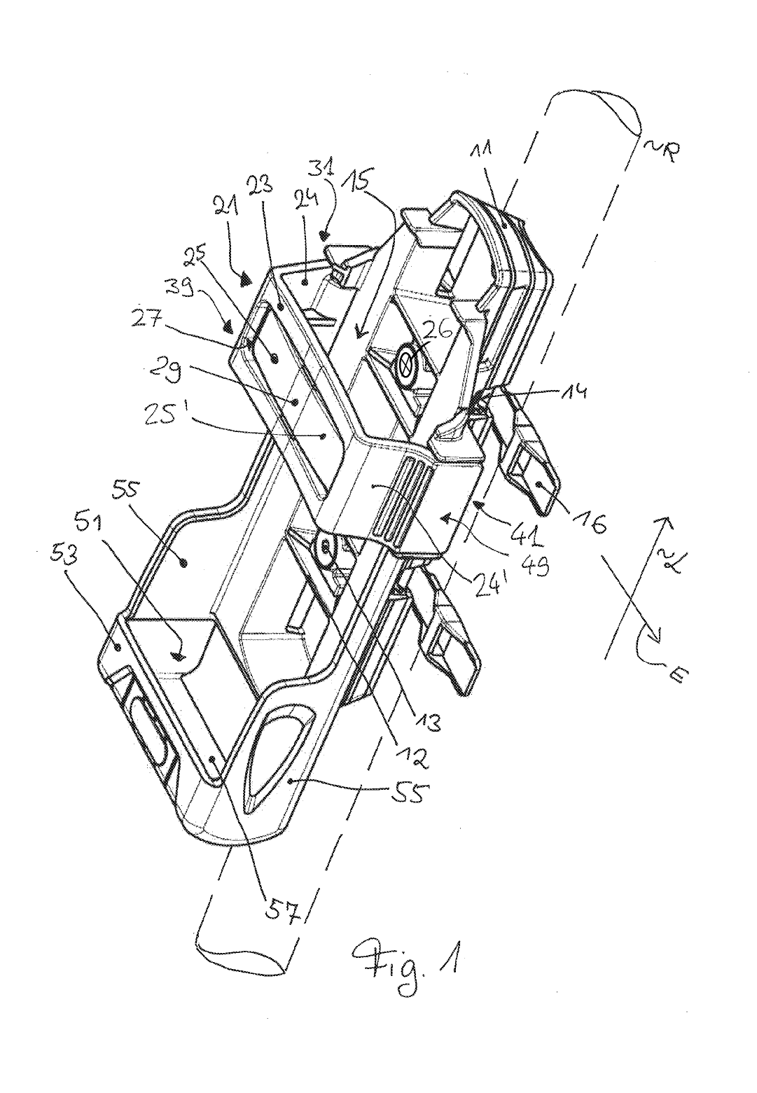

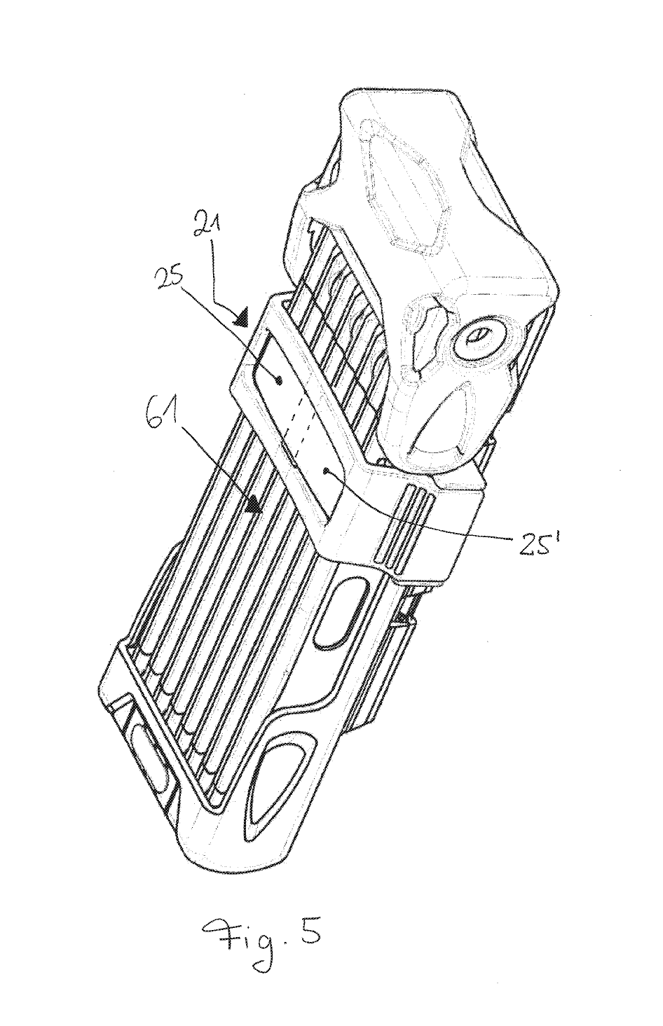

FIGS. 1 to 5 show different views of a holder for a two-wheeler lock 61 (FIG. 5) of a folding lock type. Such a folding lock typically comprises a lock body and a jointed bar hoop that is fastened thereto and that has a plurality of jointed hoop that are pivotably connected to one another and that may be folded together to form a compact package. Substantially parallelepiped-shaped dimensions with two narrow sides and two broad sides along the periphery hereby result for the two-wheeler lock 61 and in particular for the jointed bar hoop.

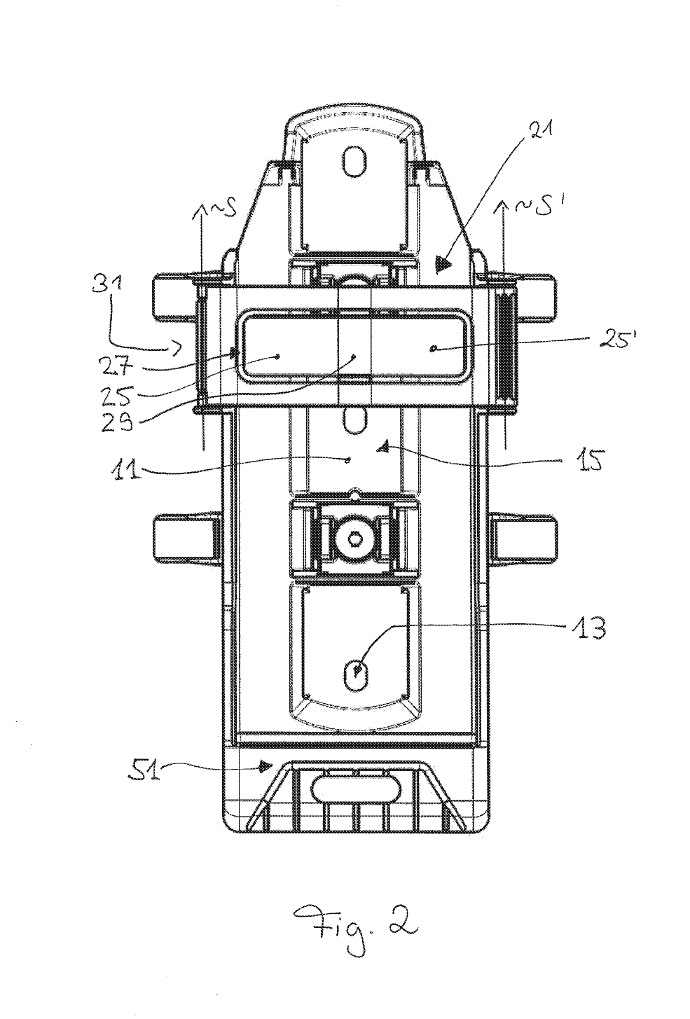

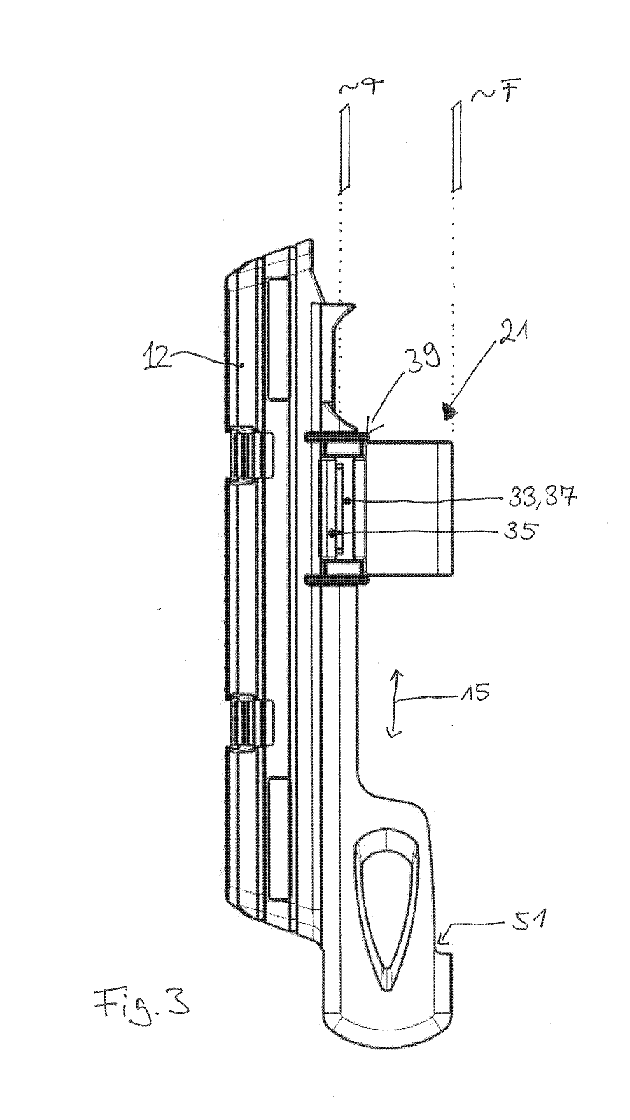

The holder for the two-wheeler lock 61 comprises a carrier 11 that serves as a base plate, that extends along a longitudinal axis L, and that has a contact plate 12 concavely arched in cross-section at its rear side. The carrier 11 may be fastened to a tube section R of a two-wheeler (FIG. 1) with the aid of a plurality of fastening openings 13 for leading through fasteners 26, such as screws, and a plurality of lateral slits 14 for leading through a respective fastening band. Flexible laterally projecting guide tabs 16 for the respective fastening band are provided at the carrier 11 or at the contact plate 12 at the level of the slits 14. The carrier 11 extends along a carrier plane T at its front side shown in FIGS. 2 and 3.

The holder has a reception region 15 in which the two-wheeler lock 61 is located in use as shown in FIG. 5. The reception region 15 is in this respect aligned in parallel with the longitudinal axis L of the carrier 11 and is bounded at the rear side by the front side or by the carrier plane T of the carrier 11, with one of the broad sides of the substantially parallelepiped-shaped two-wheeler lock 61 facing the carrier 11 and thus the tube section in the received state.

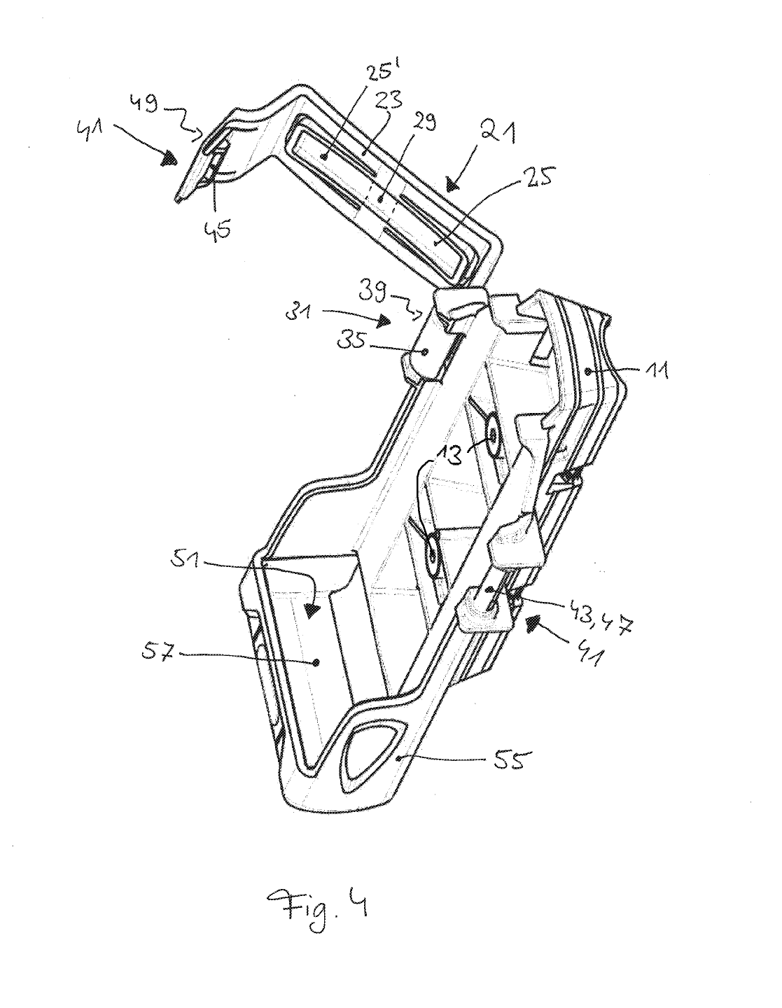

A fixing hoop (or fixing bar) 21 is pivotably supported at the carrier 11 in the upper third of the holder. The fixing hoop 21 is freely movable between an open position (FIG. 4) and a closed position (FIGS. 1 to 3 and 5). The fixing hoop 21 is of substantially U shape with a base section 23 that is aligned transversely to the longitudinal axis L of the carrier and is arranged between two limb sections 24, 24′.

The fixing hoop 21 extends overall along a direction of extent E that is aligned perpendicular to the longitudinal axis L of the carrier 11. The base section 23 is slightly convexly arched with respect to the reception region 15 for the two-wheeler lock 61 and extends substantially along a plane F that extends in parallel offset with respect to the carrier plane T of the carrier 11 (cf. FIG. 3). In the closed state (FIG. 1), the fixing hoop 21 surrounds the reception region 15 for the two-wheeler lock 61 in a U shape. The fixing hoop 21 is substantially of stable shape, with the individual sections 23, 24, 24′ of the fixing hoop 21 being elastic perpendicular to their respective directions of extent and in particular at their mutual connection points, but not along their respective directions of extent. The U shape of the fixing hoop 21 is thus elastic overall.

The base section 23 of the fixing hoop 21 is frame-shaped in the embodiment shown here. Two resilient spring sections 25, 25′ are located within the frame-shaped base section 23 which are formed integrally with the base section 23 and which are only connected to the base section 23 of the fixing hoop 21 via a common central web section 29 due to a respective U-shaped opening 27. The two spring sections 25, 25′ face away from the web section 29 in mutually offset directions and are slightly obliquely aligned with respect to the plane of extent F of the base section 23 of the fixing hoop 21 so that the spring sections 25, 25′ project into the reception region 15 for the two-wheeler lock 61.

As may above all be seen in FIGS. 2 to 4, the fixing hoop 21 is fixed to the carrier 11 with the aid of a hinge 31. The hinge 31 comprises a hinge pin 33 of the carrier 11 and a hinge bracket 35 of the fixing hoop 21 that partially peripherally engages around the hinge pin 33. It is possible due to the hinge 31 to pivot the fixing hoop 21 about a pivot axis S substantially free of forces, apart from frictional forces, between the open position and the closed position.

The carrier 11 has a latch device 41 at the side disposed opposite the hinge 31. The latch device 41 comprises a latch web 43 of the carrier 11 and a latch nose 45 of the fixing hoop 21 latched to the latch web 43 (FIG. 4). The free end of the fixing hoop 21 may be releasably fixed to the carrier 11 with the aid of the latch device 41 in the closed position.

In the lower region, the carrier 11 has a support shell 51 that is low-cut at its front side 53, while two side walls 55 extend far to the top relative to the front side 53. The bottom of the support shell 51 forms a support element 57.

As regards the use of the holder shown in FIGS. 1 to 5, the two-wheeler lock 61 may be inserted into the reception region 15 when the fixing hoop 21 is in the open position (FIG. 4). This may take in a simple manner from the front due to the low-cut front side 53 of the support shell 51. The support element 57 (bottom of the support shell 51) here serves for the lower-side support of the two-wheeler lock 61 along the longitudinal axis L.

The fixing hoop 21 may be brought into the closed position by a subsequent pivoting of the fixing hoop 21 about the pivot axis S; this is fixed by a latching of the fixing hoop 21 by the latch device 41. The two-wheeler lock 61 is thus peripherally captured in the reception region 15 of the holder (FIG. 5).

A pressing force on the two-wheeler lock 61 located in the reception region 15 which firmly fixes the two-wheeler lock 61 and stops it from slipping is generated by the spring sections 25, 25′ which are molded to the fixing hoop 21, which are resilient and which are angled with respect to the reception region 15 in the closed position of the fixing hoop 21 complementary to the elasticity of the slightly arched base section 23 of the fixing hoop 21. Any clearance of the two-wheeler lock 61 between the carrier 11 and the fixing hoop 21 is hereby eliminated and unwanted movements of the two-wheeler lock 61 in the reception region 15 are suppressed that could produce wear or noise. The fixing hoop 21 may nevertheless be closed in a comfortable manner and in particular one-handed by pivoting and latching, with a certain force effort only being required on the final closing or blocking of the fixing hoop 21 to tension the spring sections 25, 25′ and to close the latch device 41.

When the two-wheeler lock 61 is received in the reception region 15 of the holder and the fixing hoop 21 is closed, the two relatively high side walls 53 of the support shell 51 provide a high lateral stability of the held two-wheeler lock 61.

A further aspect of the shown holder comprises the ability to swap over the direction of actuation of the fixing hoop 21. The hinge pin 33 of the hinge 31 and the latch web 43 of the latch device 41 are formed in similar manners. The hinge pin 33 may thus be considered as a first connection section 37 of the carrier 11 and the latch web 43 may be considered as a second connection section 47 of the carrier 11. The end of the fixing hoop 21 comprising the hinge bracket 35 may be called a hinge end 39, while the end of the fixing hoop 21 comprising the latch nose 45 may be called a closure end 49. In the open position, the fixing hoop 21 may be removed from the carrier 11 by the separation of the hinge pin 33 and the hinge bracket 35 and may be fastened to the carrier 11 again in an alignment rotated by 180° in the plane F (FIG. 3) so that the hinge end 39 of the fixing hoop 21 is now connected in an articulated manner to the second connection section 47 of the carrier 11. The fixing hoop 21 now pivots about the pivot axis S′. To block the fixing hoop 21 in the closed position, the closure end 45 of the fixing hoop 21 is latched to the first connection section 37 of the carrier 11. Due to the symmetrically arranged similar connection sections 37, 47, the directions of opening and closing of the fixing hoop 21 may be swapped over in this manner.

In a further embodiment, not shown, it is possible that the spring section(s) 25 is/are aligned at least substantially in parallel with the longitudinal axis L of the carrier (apart from a certain slant in the direction of the reception region 15) and extend(s) over some (in particular more than half) the width or almost the total width of the fixing hoop (in particular of the base section 23). The spring section(s) 25 may in turn have partially peripheral openings so that the spring section(s) is/are resilient in a direction that extends transversely (and in some embodiments perpendicular) to the direction of extent of the respective spring section. With such an extent over some of the width of the fixing hoop, the respective spring section may contact a plurality or even all of the jointed bars of the two-wheeler lock 61 to fix the two-wheeler lock 61 in the reception region 15 and in particular also to prevent a shaking movement of the individual jointed bars relative to one another.

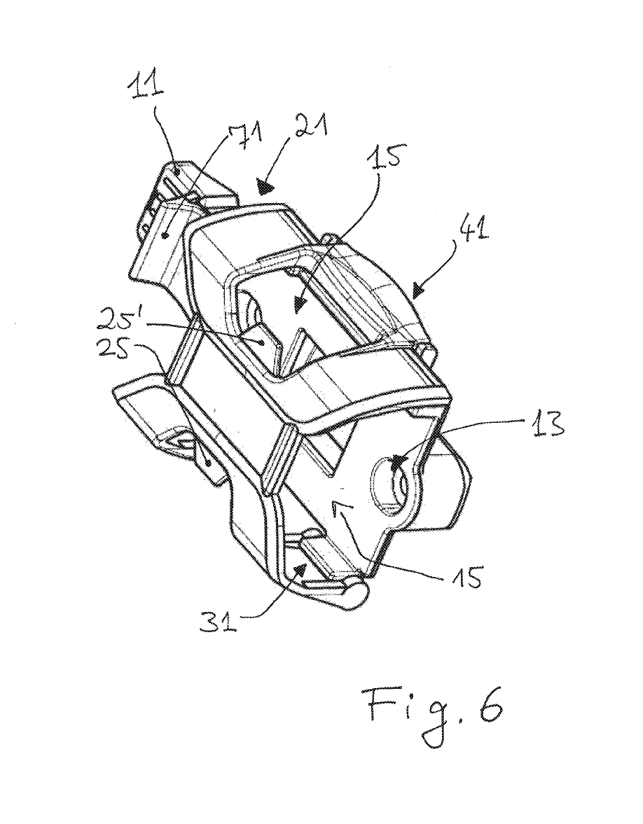

FIG. 6 shows a further embodiment of a holder for a two-wheeler lock. The fixing hoop 21 is here substantially of X shape. The fixing hoop 21 in turn has two spring sections 25, 25′ in a central region along the longitudinal axis L that are formed integrally with the fixing hoop 21 and that face in mutually opposite directions in a laterally free-standing manner, with the two spring sections 25, 25′, however, being slightly inclined in the direction of the reception region 15 for the two-wheeler lock (not shown in FIG. 6).

Furthermore, only a support element 71 is provided in an upper region of the carrier 11 instead of the support shell 51 in accordance with FIGS. 1 to 5, with the support element projecting from the carrier 11 in the direction of the reception region 15 for the two-wheeler lock. The support element 71 has the shape of a support web that extends substantially along an orthogonal plane with respect to the longitudinal axis L, but that tapers toward its free end. The support element 71 is configured to engage into a cut-out of the two-wheeler lock that is formed between the lock body and the jointed bar hoop.

In the above-described embodiments, a simple, intuitive and in particular one-handed handling of the two-wheeler lock holder is made possible due to the easy opening and closing of the freely pivotable fixing hoop 21. A firm fixing of a two-wheeler lock 61 within the reception region 15 of the holder is in particular achieved by the resilient spring sections 25, 25′. The holder is suitable both for left handed persons and right handed persons and for different parking positions having different accessibilities of the holder due to the possibility of swapping over the opening and closing directions in the embodiment in accordance with FIGS. 1 to 5.

1. A holder for a two-wheeler lock of a folding lock type, the holder comprising
a carrier that extends along a longitudinal axis, the carrier bounds a reception region configured to receive the two-wheeler lock, and
a fixing hoop that is supported at the carrier pivotable between an open position and a closed position, with the fixing hoop being configured to fix the two-wheeler lock in the reception region in the closed position,
wherein the fixing hoop has at least one spring section that is configured to exert a pressing force on the lock in the closed position of the fixing hoop.

2. The holder in accordance with claim 1, wherein the fixing hoop is aligned transversely to the longitudinal axis of the carrier.

3. The holder in accordance with claim 1, wherein the at least one spring section is resilient.

4. The holder in accordance with claim 1, wherein the at least one spring section is aligned obliquely with respect to the direction of extent of the fixing hoop.

5. The holder in accordance with claim 1, wherein the at least one spring section is formed integrally at the fixing hoop.

6. The holder in accordance with claim 1, wherein the at least one spring section is formed by a multi-side opening at the fixing hoop.

7. The holder in accordance with claim 1, wherein the fixing hoop has two spring sections.

8. The holder in accordance with claim 7, wherein the two spring sections face in mutually at least substantially opposite directions.

9. The holder in accordance with claim 1, wherein the fixing hoop is elastic perpendicular to its direction of extension, but not along its respective direction of extension.

10. The holder in accordance with claim 1, wherein the fixing hoop or a part of the fixing hoop is convexly arched with respect to the reception region.

11. The holder in accordance with claim 1, wherein the fixing hoop peripherally closes the reception region in the closed position.

12. The holder in accordance with claim 1, wherein the fixing hoop is substantially of U shape.

13. The holder in accordance with claim 1, wherein the fixing hoop is at least substantially of stable shape.

14. The holder in accordance with claim 1, wherein the fixing hoop is supported at the carrier pivotable by at least one hinge.

15. The holder in accordance with claim 1, wherein the fixing hoop is pivotable about a pivot axis that extends in parallel with the longitudinal axis of the carrier.

16. The holder in accordance with claim 1, wherein the fixing hoop has a free end that is latchable to the carrier by a latch device.

17. The holder in accordance with claim 1, wherein the fixing hoop has at least one hinge end and a closure end;
wherein the carrier has a first connection section and a second connection section similar to the first connection section, respectively, at two sides of the reception region;
wherein the fixing hoop is selectively fixable in a first configuration or in a second configuration to the carrier;
wherein the hinge end of the fixing hoop is fastened to the first connection section of the carrier in the first configuration and the closure end is blockable at the second connection section; and
wherein the hinge end of the fixing hoop is fastened to the second connection section of the carrier in the second configuration and the closure end is blockable at the first connection section.

18. The holder in accordance with claim 1, wherein the carrier has a support element that is configured to support the two-wheeler lock received in the reception region against a movement along the longitudinal axis of the carrier.

19. The holder in accordance with claim 18, wherein the support element projects laterally with respect to the longitudinal axis of the carrier so as to be configured to support the two-wheeler lock at a front side or to engage into a portion of the two-wheeler lock.

20. The holder in accordance with claim 18, wherein the support element is at least substantially rigidly connected to the carrier.

21. The holder in accordance with claim 1 further comprising the two-wheeler lock.

22. A lock arrangement comprising:
a two-wheeler lock of a folding lock type, the two-wheeler lock has a lock body and a jointed bar hoop which is fastened to the lock body and which has a plurality of jointed bars which are pivotably connected to one another and that are folded together to form an axially parallel arrangement; and
a holder configured to hold the two-wheeler lock, the holder includes a carrier and a fixing hoop,
the carrier extends along a longitudinal axis, the carrier bounds a reception region that receives the two-wheeler lock, and
the fixing hoop is supported at the carrier pivotable between an open position and a closed position, with the fixing hoop being configured to fix the two-wheeler lock in the reception region in the closed position,
wherein the fixing hoop has at least one spring section that is configured to exert a pressing force on the lock in the closed position of the fixing hoop.
